(19) United States
(12) Patent Application Publication
(10) Pub. No.: US 2017/0036531 A1
(43) Pub. Date: Feb. 9, 2017

(54) FUEL TANK ISOLATION VALVE HAVING BYPASS CONFIGURATION

(71) Applicant: Eaton Corporation, Cleveland, OH (US)

(72) Inventors: Raymond Bruce McLauchlan, Macomb, MI (US); Steven Lee Ambrose, Farmington Hills, MI (US); Jeffrey Bernard Smith, Rochester Hills, MI (US); Mustafa Huseyin, Karlsruhe (DE)

(73) Assignee: Eaton Corporation, Cleveland, OH (US)

(21) Appl. No.: 15/333,241

(22) Filed: Oct. 25, 2016

Related U.S. Application Data
(63) Continuation-in-part of application No. PCT/US2015/027740, filed on Apr. 27, 2015.
(60) Provisional application No. 61/984,424, filed on Apr. 25, 2014.
(60) Provisional application No. 62/411,993, filed on Oct. 24, 2016.

(51) Int. Cl. B60K 15/035; B60K 15/03; F02M 25/08

(52) U.S. Cl. CPC B60K 15/03504; F02M 25/0854; F02M 25/0836; B60K 15/03006; B60K 2015/03296; B60K 2015/03026

(57) ABSTRACT

A fuel tank system constructed in accordance to one example of the present disclosure includes a fuel tank, a purge canister, a valve assembly and a bypass means. The valve assembly can be fluidly coupled between the fuel tank and the purge canister and that selectively controls fuel vapor flow between the fuel tank and the purge canister. The bypass means can selectively bypass fuel vapor around at least a portion of the valve assembly from the fuel tank to the purge canister. The bypass means can include a bypass valve.

### CROSS-REFERENCE TO RELATED APPLICATIONS

This application is a continuation-in-part of International Application No. PCT/US2015/027740 filed Apr. 27, 2015, which claims the benefit of U.S. patent application Ser. No. 61/984,424 filed on Apr. 25, 2014. This application claims the benefit of U.S. patent application Ser. No. 62/411,993 filed on Oct. 24, 2016. The disclosures of the above applications are incorporated herein by reference.

### FIELD

The present disclosure relates generally to fuel tanks on passenger vehicles and more particularly to a fuel tank isolation valve having a bypass configuration that vents vapor from the fuel tank to a canister.

### BACKGROUND

Fuel vapor emission control systems are becoming increasingly more complex, in large part in order to comply with environmental and safety regulations imposed on manufacturers of gasoline powered vehicles. Along with the ensuing overall system complexity, complexity of individual components within the system has also increased. Certain regulations affecting the gasoline-powered vehicle industry require that fuel vapor emission from a fuel tank's ventilation system be stored during periods of an engine's operation. In order for the overall vapor emission control system to continue to function for its intended purpose, periodic purging of stored hydrocarbon vapors is necessary during operation of the vehicle.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A fuel tank system constructed in accordance to one example of the present disclosure includes a fuel tank, a purge canister, a valve assembly and a bypass means. The valve assembly can be fluidly coupled between the fuel tank and the purge canister and that selectively controls fuel vapor flow between the fuel tank and the purge canister. The bypass means can selectively bypass fuel vapor around at least a portion of the valve assembly from the fuel tank to the purge canister. The bypass means can include a bypass valve.

In other configurations, the valve assembly can comprise an over-pressure relief valve having a piston and a seal that collectively translates relative to a seat between open and closed positions. The bypass means can comprise a pushpin that is selectively movable to urge the seal of the over-pressure relief valve off of the corresponding seat. The valve assembly can be disposed in a housing. The pushpin can extend out of the housing.

According to other features, the bypass means can comprise an over-pressure relief valve having a seal formed of magnetic material. The seal can selectively engage a corresponding seat in a closed position. The seal can be selectively urged away from the corresponding seat upon a magnet being placed proximate to the seal. The seal can be normally urged toward the corresponding seat by a spring.

In other features, the valve assembly can further comprise a normally closed flow restrictor having a seal that translates relative to a seat between open and closed positions. The bypass means can comprise a pull pin that extends through the housing. Manual actuation of the pull pin can urge the seal off of the seat to the open position. The bypass means can comprise one of a button, a lever, an arm and a deformable housing. Movement of the bypass means can urge the seal off of the seat to the open position.

A fuel tank system constructed in accordance to another example of the present disclosure can include a fuel tank, a purge canister, a housing and a valve assembly. The valve assembly can be configured in the housing and be fluidly coupled between the fuel tank and the purge canister. The valve assembly selectively controls fuel vapor between the fuel tank and the purge canister. The valve assembly can include an over-pressure relief valve that includes a seal. The seal can translate between (i) an open position wherein the seal is offset from a corresponding seat and fuel vapor flows from the fuel tank to the purge canister and (ii) a closed position wherein the seal is engaged to the seat and fuel vapor is inhibited from flowing from the fuel tank to the purge canister. A device can selectively urge the seal from the closed position to the open position.

According to additional features, the device can include a pushpin that extends from the housing and that is selectively movable from an unactuated position to an actuated position. In the actuated position, the pushpin manually urges the seal off of the corresponding seat thereby creating a fuel vapor path from the fuel tank to the purge canister. The pushpin can be biased toward the unactuated position. In one example, the seal can include magnetic material. The device can include a magnet. Placement of the magnet proximate to the seal can urge the seal to translate away from the seat thereby creating a fuel vapor path from the fuel tank to the purge canister.

A fuel tank system constructed in accordance to another example of the present disclosure can include a fuel tank, a purge canister, a housing, a valve assembly and a flow restrictor. The valve assembly can be configured in the housing and be fluidly coupled between the fuel tank and the purge canister. The valve assembly can selectively control fuel vapor between the fuel tank and the purge canister. The flow restrictor can be arranged in the housing and have a first seal that selectively translates between (i) an open position wherein the first seal is offset from a first seat and fuel vapor flows from the fuel tank to the purge canister and (ii) a closed position wherein the first seal is engaged to the first seat and fuel vapor is inhibited from flowing from the fuel tank to the purge canister. A device can selectively urge the first seal from the closed position to the open position.

According to other features, the device can include a pull pin that extends from the housing. Manual actuation of the pull pin can urge the first seal off of the first seat to the open position. In other examples, the device can comprise one of a button, a lever, an arm and a deformable housing. Movement of the device urges the first seal off of the first seat to the open position. The valve assembly can further include a valve assembly having an over-pressure relief valve. The over-pressure relief valve can include a second seal that translates between (i) an open position wherein the second seal is offset from a corresponding second seat and fuel vapor flows from the fuel tank to the purge canister and (ii) a closed position wherein the second seal is engaged to the second seat and fuel vapor is inhibited from flowing from the fuel tank to the purge canister.

### BRIEF DESCRIPTION OF THE DRAWINGS

The present disclosure will become more fully understood from the detailed description and the accompanying drawings, wherein:

FIG. 1 is a schematic illustration of a fuel tank system having an evaporative emissions control system including a valve assembly constructed in accordance to one example of the present disclosure;

FIG. 2 is a schematic illustration of a fuel tank configuration having a normally closed bypass valve according to one example of the present disclosure;

FIG. 3A is schematic illustration of a fuel tank configuration having a manually operable push pin according to one example of the present disclosure and shown in an unactuated position;

FIG. 3B is a schematic illustration of the fuel tank configuration of FIG. 3A and shown with the push pin in an actuated position;

FIG. 4A is a schematic illustration of a fuel tank configuration having an over-pressure relief valve including a seal formed of magnetic material and shown in a closed position;

FIG. 4B is a schematic illustration of the fuel tank configuration of FIG. 4A and shown with the seal in an open position;

FIG. 5A is a schematic illustration of a fuel tank configuration having a manually operable pull pin according to one example of the present disclosure and shown with the pull pin in an unactuated position;

FIG. 5B is a schematic illustration of the fuel tank configuration of FIG. 5A and shown with the pull pin in an actuated position;

FIG. 6A is a schematic illustration of a fuel tank configuration having a means configured to urge a flow restrictor seal off its seat and shown with the means in an unactuated position

FIG. 6B is a schematic illustration of the fuel tank configuration of FIG. 6A and shown with the means in an actuated position;

FIG. 7 is a schematic illustration of a fuel tank configuration having a connector that selectively connects the fuel tank and the purge canister to bypass the valve assembly according to one example of the present disclosure;

FIG. 8 is a top perspective view of a valve assembly constructed in accordance to another example of the present disclosure;

FIG. 9 is a side view of the valve assembly of FIG.8;

FIG. 10A is a partial cutaway view of the valve assembly of FIG. 8 illustrating a manually actuated pushpin used to open an overpressure relief valve of the valve assembly, the pushpin shown in an unactuated position; and

FIG. 10A is a partial cutaway view of the valve assembly of FIG. 10A showing the pushpin in an actuated position.

### DETAILED DESCRIPTION

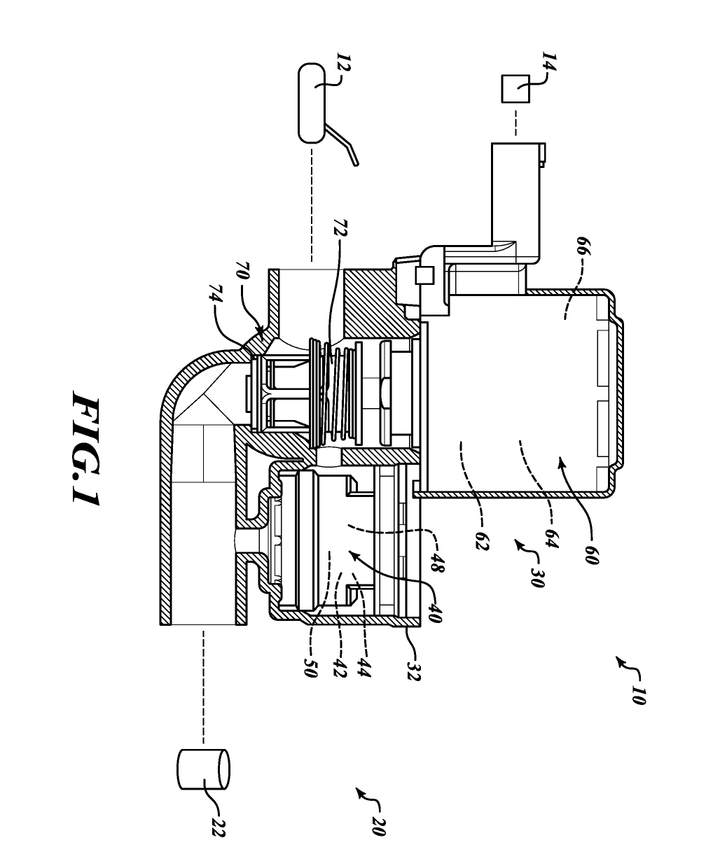

With initial reference to FIG. 1, a fuel tank system constructed in accordance to one example of the present disclosure is shown and generally identified at reference number 10. The fuel tank system 10 can generally include a fuel tank 12 configured as a reservoir for holding fuel to be supplied to an internal combustion engine via a fuel delivery system, which includes a fuel pump (not specifically shown). A controller 14 can be configured to regulate the operation of the engine and its fuel delivery system. The fuel tank 12 is operatively connected to an evaporative emissions control system 20 that includes a purge canister 22 adapted to collect fuel vapor emitted by the fuel tank 12 and to subsequently release the fuel vapor to the engine. The controller 14 can also be configured to regulate the operation of evaporative emissions control system 20 in order to recapture and recycle the emitted fuel vapor.

The evaporative emissions control system 20 includes a valve assembly 30. Additional description of the valve assembly 30 may be found in commonly owned U.S. Pat. No. 8,944,100, the contents of which are expressly incorporated herein by reference. In general, the valve assembly 30 may control fuel vapor flow between the fuel tank 12 and the purge canister 22. While the valve assembly 30 is shown located between the fuel tank 12 and the purge canister 22, the valve assembly 30 may be configured elsewhere such as between the purge canister 22 and the engine. The controller 14 can be adapted to regulate the operation of a valve assembly 30 to selectively open and close the valve, in order to provide over-pressure and vacuum relief for the fuel tank 12. The valve assembly 30 can be configured to control a flow of fuel vapor between the fuel tank 12 and the purge canister 22. The valve assembly 30 includes a housing 32, which retains all internal components of the valve assembly 30. The housing 32 can connect to the fuel tank 12 via a first connector (not specifically shown) and to the purge canister 22 via a second connector (not specifically shown).

The housing 32 accommodates an over-pressure relief (OPR) valve 40. The OPR valve 40 includes a piston 42, which may be formed from a suitable chemically resistant material such as an appropriate plastic or aluminum. The OPR valve 40 can also include a compliant seal 44, which may be formed from a suitable chemically resistant elastomeric material.

The piston 42 and the seal 44 may be combined into a unitary piston assembly via an appropriate manufacturing process such as over-molding. The piston 42 and the seal 44 are urged to close a passage 48 by a spring 50. The OPR valve 40 is configured to facilitate opening a first fuel vapor flow path being traversed by the fuel vapor flowing in a direction from the fuel tank 12 toward the purge canister 18 when the fuel tank 12 is above a first predetermined pressure value. The first predetermined pressure value is preferably a positive number, representing an extreme or over-pressure condition of the fuel tank 12.

The valve assembly 30 can include a solenoid assembly 60 arranged inside the housing 32. The solenoid assembly 60 is adapted to receive electrical power from a vehicle alternator or from an energy-storage device (not shown), and be triggered or energized by a control signal from the controller 14. The solenoid assembly 60 can include an armature 62, a solenoid spring 64 and a coil 66. The solenoid spring 64 can be configured to generate a force sufficient to urge armature 62 out of the solenoid assembly 60, when the solenoid assembly 60 is not energized. The coil 66 can be configured to energize solenoid assembly 60, and to withdraw the armature 62 into the solenoid assembly 60 by overcoming the biasing force of the solenoid spring 64 and exposing an orifice to allow vapor to flow therethrough.

The valve assembly 30 can additionally include a flow restrictor 70. The flow restrictor 70 can be arranged inside the housing 32. The flow restrictor 70 includes a piston 72 which may be formed from a suitable chemically resistant material such as an appropriate plastic or aluminum. The flow restrictor 70 also includes a compliant seal 74, which may be formed from a suitable chemically resistant rubber. The flow restrictor 70 is configured to be normally closed.

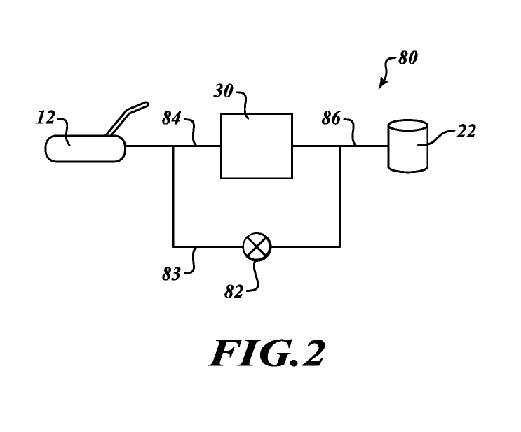

With reference now to FIG. 2, a fuel tank configuration constructed in accordance to one example of the present disclosure is shown and identified at reference 80. The fuel tank configuration 80 includes the fuel tank 12, the purge canister 22 and the valve assembly 30. A normally closed bypass valve 82 is incorporated along a bypass fluid line 83. The bypass fluid line 83 is fluidly connected between a first vapor line 84 connected between the fuel tank 12 and the valve assembly 30 and a second vapor line 86 connected between the valve assembly 30 and the purge canister 22. The fuel tank configuration 80 can contain the fuel vapor between the fuel tank 12 and the purge canister 22. The bypass valve 82 can be opened to fluidly connect the fuel tank 12 to the purge canister 22 which bypassing the valve assembly 30. The fuel tank configuration can be particularly useful while adding fuel to the fuel tank 12 while the valve assembly 30 is prevented from venting to the purge canister 22 (such as when the valve assembly 30 has yet to be connected to power).

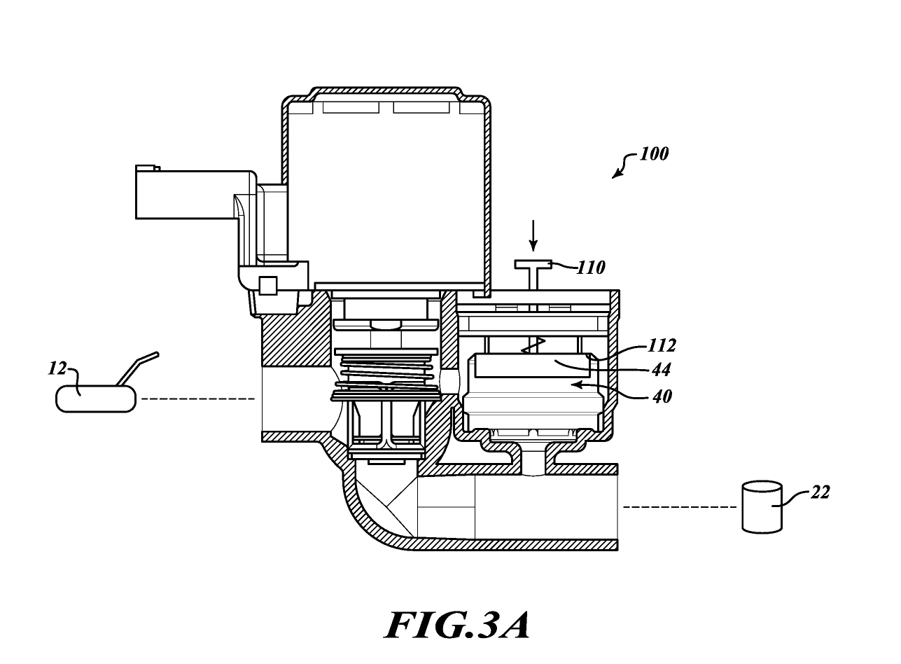

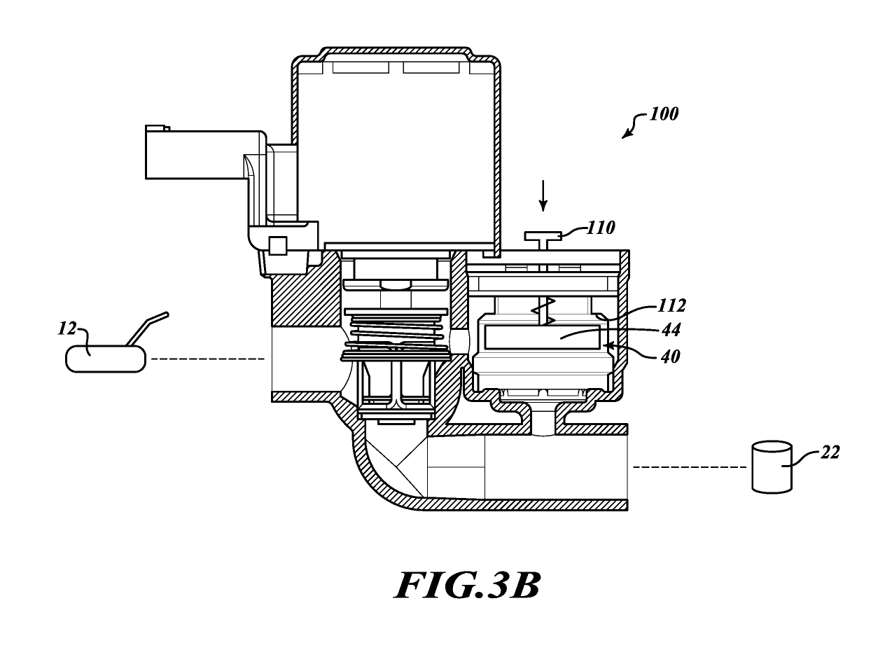

Turning now to FIGS. 3A and 3B, a fuel tank configuration constructed in accordance to another example of the present disclosure is shown and identified at reference 100. Unless described otherwise, the fuel tank configuration 100 can comprise the same features as described above with respect to the fuel tank system 10. The fuel tank configuration 100 includes a manually operable pushpin 110 that can be manually actuated to open the OPR valve 40. Specifically, the pushpin 110 can be translated from an unactuated position (FIG. 3A) to an actuated position (FIG. 3B). In the actuated position, the pushpin is moved in a direction to move the seal 44 off a corresponding seat 112 at the passage 48 from a closed position to an open position. When the seal 44 is moved off its seat 112 from actuation of the pushpin 110, the tank 12 is vented to the purge canister 22. In one example, the pushpin 110 is biased toward the closed position. Other configurations are contemplated that can cause the seal 44 to move off the seat 112.

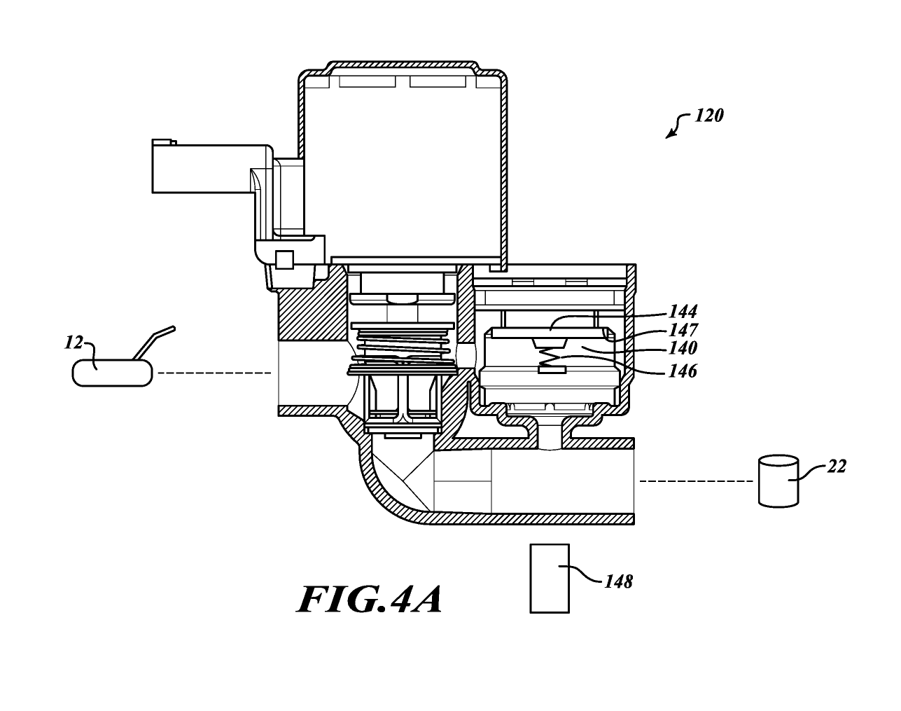

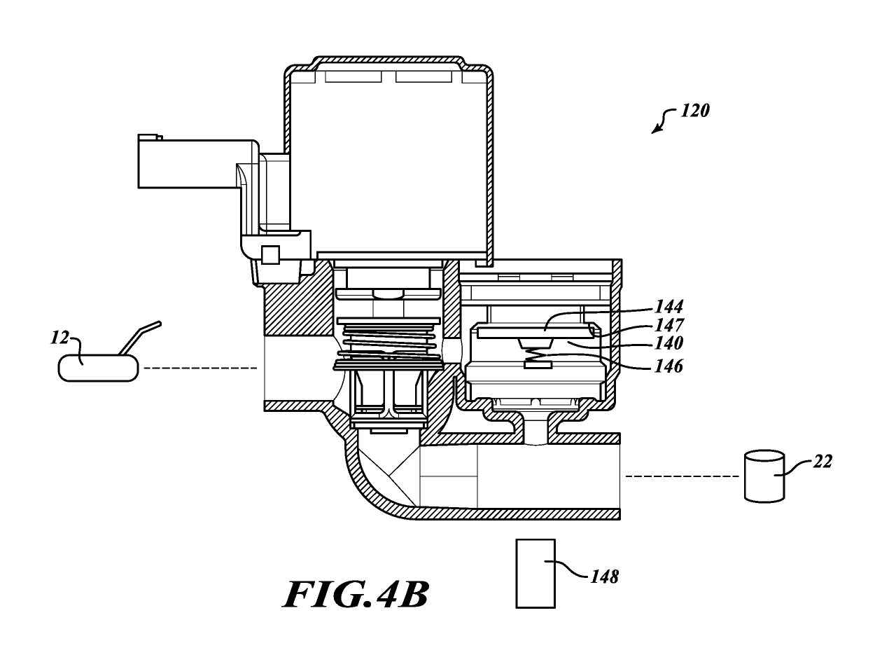

With reference to FIGS. 4A and 4B, a fuel tank configuration constructed in accordance to another example of the present disclosure is shown and identified at reference 120. Unless described otherwise, the fuel tank configuration 120 can comprise the same features as identified above with respect to the fuel tank system 10. The fuel tank configuration 120 includes an OPR valve 140 having a seal 144 that is formed of magnetic material. A spring 146 can bias the seal 144 against its seat. The seal 144 can be urged from a closed position (FIG. 4A) away from its corresponding seat 147 to an open position (FIG. 4B) and against the bias of the spring 146 by an external magnet 148. In this regard, the magnet 148 can be used to pull the seal 144 off of its seat. When the seal 144 is moved off its seat 147 from the magnet 148, the tank 12 is vented to the purge canister 22. Other configurations are contemplated that can cause the seal 144 to move off the seat 147.

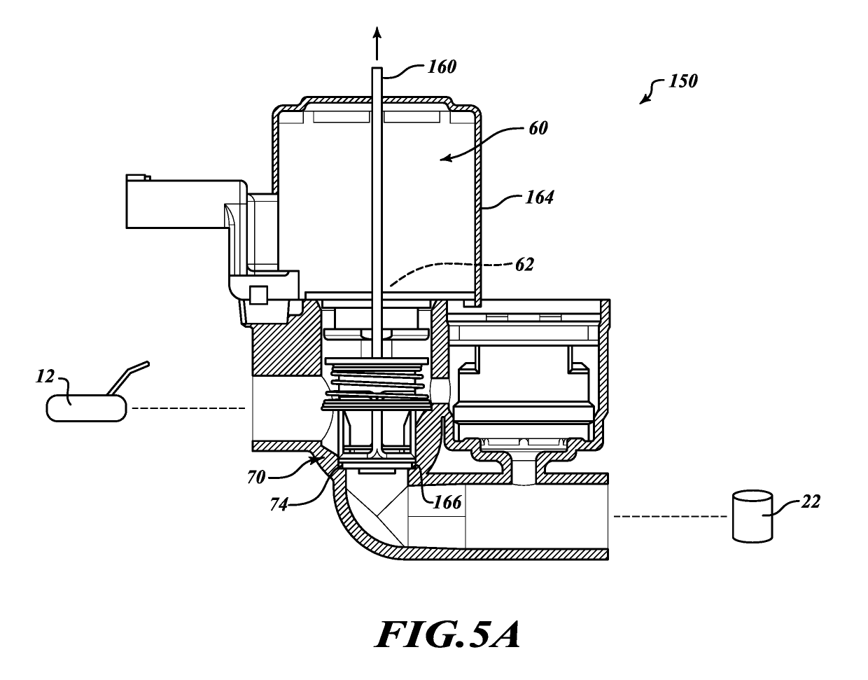

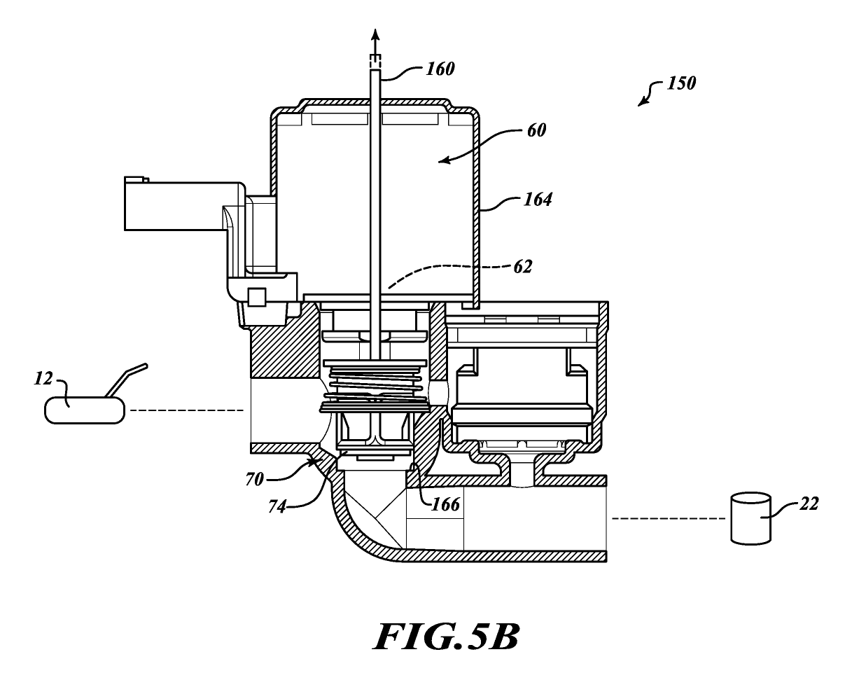

Turning now to FIGS. 5A and 5B, a fuel tank configuration constructed in accordance to another example of the present disclosure is shown and identified at reference 150. Unless described otherwise, the fuel tank configuration 150 can comprise the same features as identified above with respect to the fuel tank system 10. The fuel tank configuration 150 includes a pull pin 160 that extends through a canister 164 that houses the solenoid assembly 60. The pull pin 160 can be coupled to the armature 62 allowing the armature 62 and compliant seal 74 to be pulled up and off a seat 166. In this regard, actuation of the pull pin 160 can urge the compliant seal 74 from a closed position (FIG. 5A) to an open position (FIG. 5B). Other configurations are contemplated that can cause the compliant seal 74 to move from the closed position to the open position.

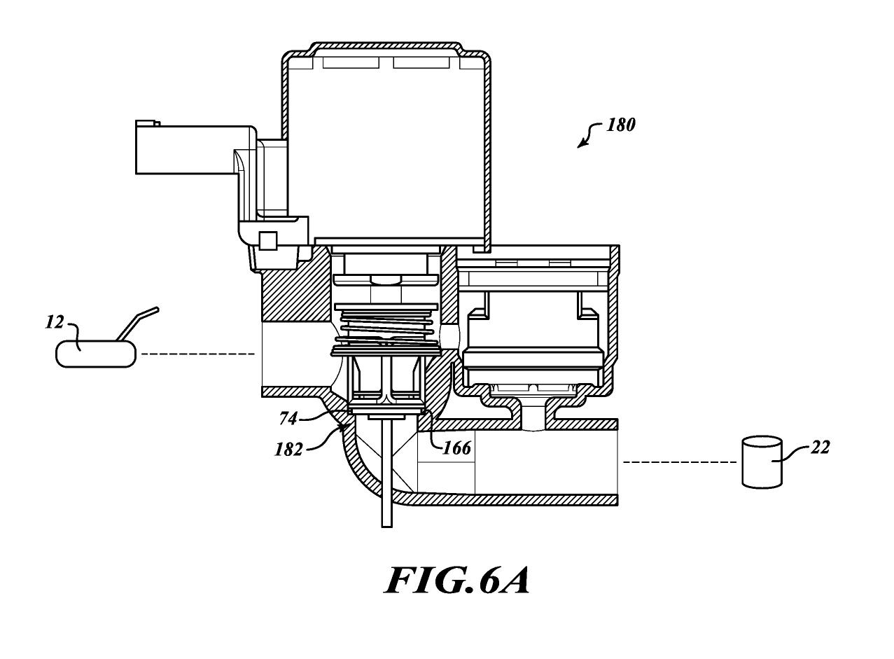

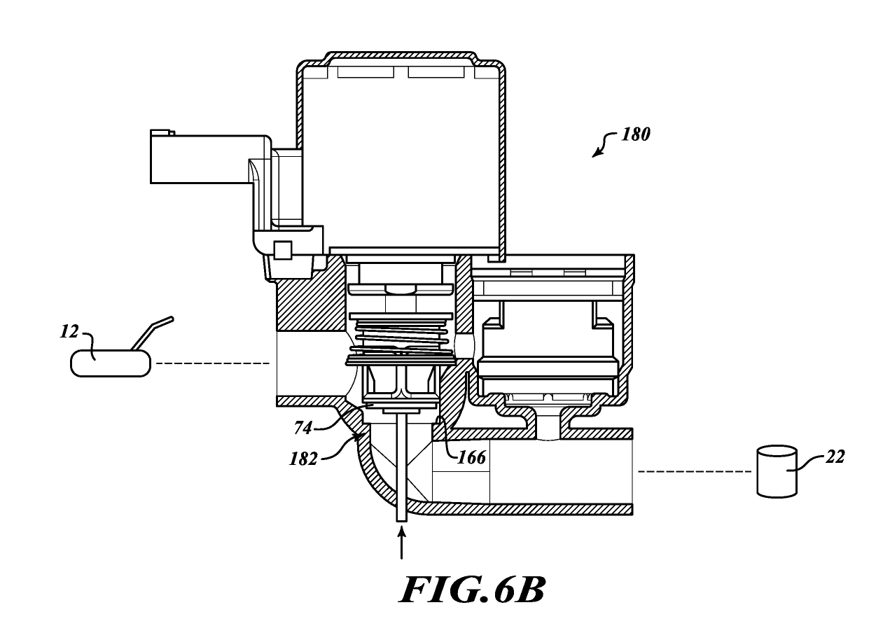

With reference now to FIGS. 6A and 6B, a fuel tank configuration constructed in accordance to another example of the present disclosure is shown and identified at reference 180. Unless described otherwise, the fuel tank configuration 180 can comprise the same features as identified above with respect to the fuel tank system 10. The fuel tank configuration 180 includes a means 182 that is configured to urge the compliant seal 74 up and off of its seat 166. The means 182 can move between an unactuated position (FIG. 6A) and an actuated position (FIG. 6B). The means 182 can comprise a button, a lever an arm or other structure that connects to the compliant seal 74 to urge the compliant seal 74 off of its seat. In other examples, the means 182 can include a deformable housing portion that can be deflected to gain access to the compliant seal 74.

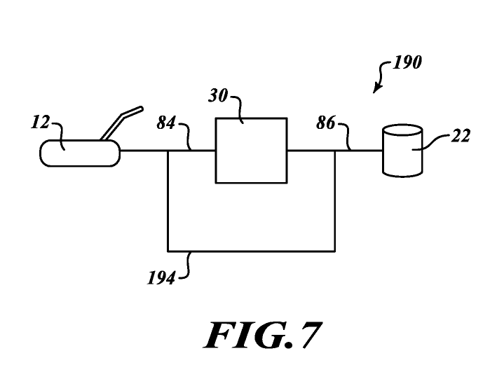

With reference to FIG. 7, a fuel tank configuration constructed in accordance to another example of the present disclosure is shown and identified at reference 190. Unless described otherwise, the fuel tank configuration 190 can comprise the same features as identified above with respect to the fuel tank system 10. The fuel tank configuration 190 includes the fuel tank 12, the purge canister 22 and the valve assembly 30. A connector 194 can be selectively coupled between the first vapor line 84 and the second vapor line 86. The connector 194 can comprise any tool, device or mechanism that fluidly connects the fuel tank 12 with the purge canister 22 while bypassing the valve assembly 30.

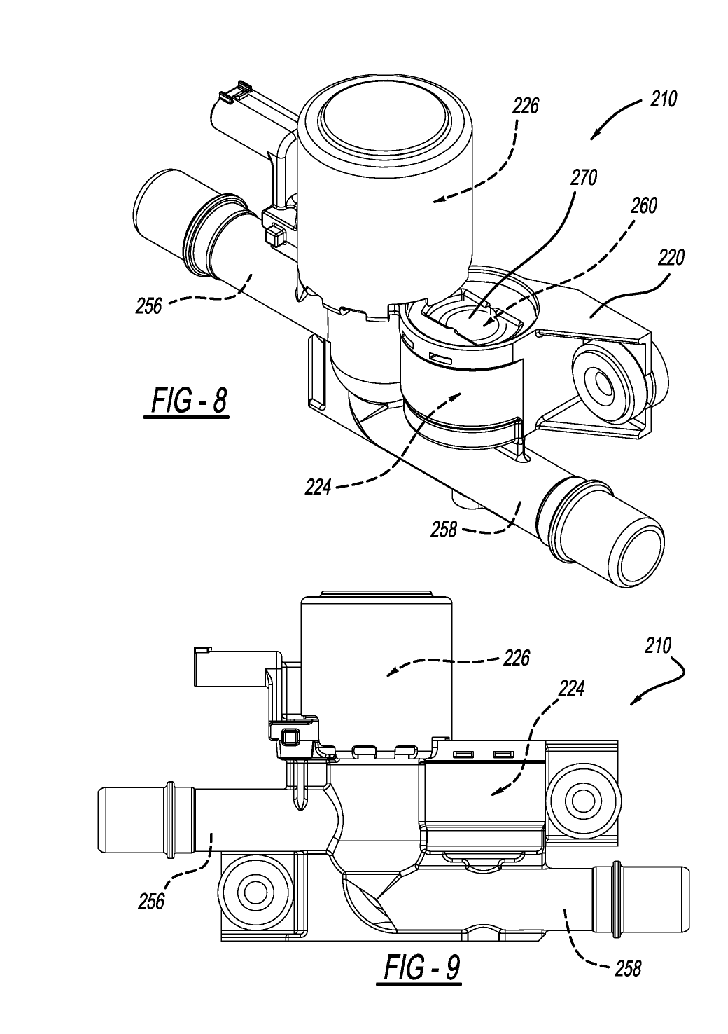

Turning now to FIGS. 8-10B, a valve assembly constructed in accordance to additional features is shown and generally identified at reference 210. The valve assembly 210 can be used in the fuel tank system 10 described above to control a flow of fuel vapor between the fuel tank 12 and the purge canister 22. Unless otherwise described herein, the valve assembly 210 can include the features described above with respect to the valve assembly 30.

The valve assembly 210 includes a housing 220 that accommodates an OPR valve 224 and a solenoid assembly 226. The OPR valve 224 includes a piston 230 that is movable between an engaged and sealed position with a compliant seal 232. The piston 230 can be formed from a suitable chemically resistant material such as an appropriate plastic or aluminum. The compliant seal 232 can be formed from a suitable chemically resistant elastomeric material. The piston 230 and the seal 232 may be combined into a unitary piston assembly via an appropriate manufacturing process such as over-molding. The piston 230 and the seal 232 are urged to close a passage 238 by a spring 250. The OPR valve 224 is configured to facilitate opening a first fuel vapor flow path being traversed by the fuel vapor flowing into the valve assembly 210 through inlet 254 in a direction from the fuel tank 12 and out of the valve assembly 210 through the outlet 258 toward the purge canister 18 when the fuel tank 12 is above a first predetermined pressure value. The first predetermined pressure value is preferably a positive number, representing an extreme or over-pressure condition of the fuel tank 12.

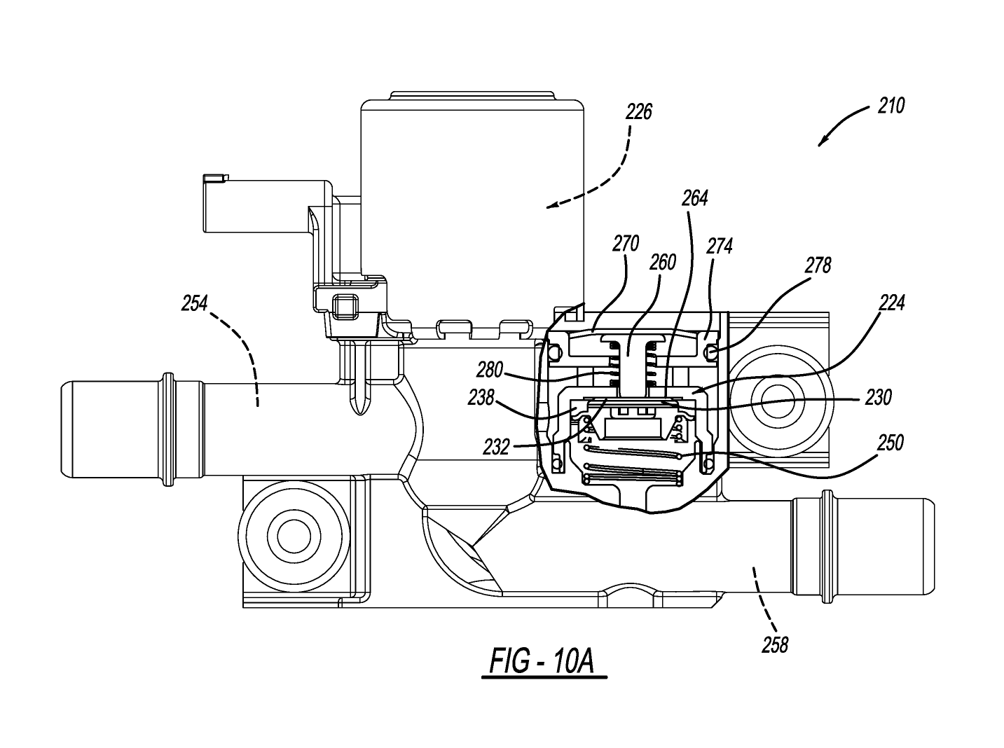

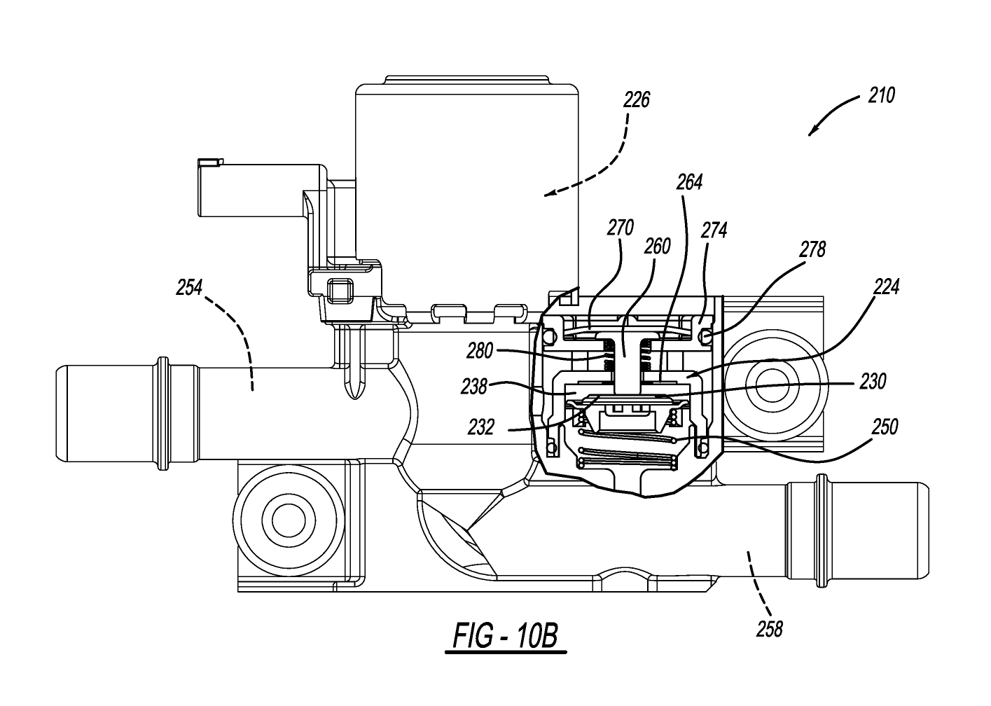

The valve assembly 210 includes a manually operable pushpin 260 that can be manually actuated to open the OPR valve 224. Specifically, the pushpin 260 can be translated from an unactuated position (FIG. 10A) to an actuated position (FIG. 10B). In the actuated position, the pushpin 260 is moved in a direction to move the seal 232 off of a corresponding valve seat 264 at the passage 238 from a closed position to an open position. When the seal 232 is moved off its seat 264 from actuation of the pushpin 260, the tank 12 is vented to the purge canister 22. In one example, the pushpin 260 is biased toward the closed position. Other configurations are contemplated that can cause the seal 232 to move off the seat 264.

The pushpin 260 is enclosed in a flexible diaphragm 270 that sealingly encloses the pushpin 260. The flexible diaphragm 270 can be made of rubber or other suitable flexible water-resistant material. The flexible diaphragm 270 can be sealingly coupled to a pushpin support member 274. The flexible diaphragm 270 can keep debris out of the housing 220. The pushpin support member 274 can be sealingly coupled to the housing 220 by an o-ring 278. A pushpin biasing member 280 can urge the pushpin 260 into the unactuated position.

It will be appreciated that for hybrid vehicles during electric operation where the fuel tank is not being used and is sealed off. Sloshing around of fuel in the fuel tank can create increased pressures. The OPR valve 224 can regulate the pressure to the purge canister 22 so the purge canister 22 does not become oversaturated. In other examples, during refueling, opening of the fuel cap door (or other trigger such as a user actuated button) can energize the solenoid assembly 226 to purge the tank to relieve the pressure. In instances where the solenoid assembly 226 may not be properly functioning, an individual such as a service technician can depress the pushpin 260 to manually relieve the pressure. The pushpin 260 is also reusable and can be actuated more than one time to relieve pressure.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A fuel tank system comprising:
a fuel tank;
a purge canister;
a valve assembly that is fluidly coupled between the fuel tank and the purge canister and that selectively controls fuel vapor flow between the fuel tank and the purge canister; and
a bypass means that selectively bypasses fuel vapor around at least a portion of the valve assembly from the fuel tank to the purge canister.

2. The fuel tank system of claim 1 wherein the bypass means comprises a bypass valve.

3. The fuel tank system of claim 1 wherein the valve assembly comprises an over-pressure relief valve having a piston and a seal that collectively translate relative to a seat between open and closed positions.

4. The fuel tank system of claim 3 wherein the bypass means comprises a pushpin that is selectively movable to urge the seal of the over-pressure relief valve off of the corresponding seat.

5. The fuel tank system of claim 4 wherein the valve assembly is disposed in a housing and wherein the pushpin is enclosed in a flexible diaphragm that sealingly encloses the pushpin, the pushpin biased toward a closed position.

6. The fuel tank system of claim 1 wherein the bypass means comprises an over-pressure relief valve having a seal formed of magnetic material, the seal selectively engaging a corresponding seat in a closed position.

7. The fuel tank system of claim 6 wherein the seal is selectively urged away from the corresponding seat upon a magnet being placed proximate to the seal.

8. The fuel tank system of claim 7 wherein the seal is normally urged toward the corresponding seat by a spring.

9. The fuel tank system of claim 1 wherein the valve assembly comprises a normally closed flow restrictor having a seal that translates relative to a seat between open and closed positions.

10. The fuel tank system of claim 9 wherein the bypass means comprise a pull pin that extends through the housing, wherein manual actuation of the pull pin urges the seal off of the seat to the open position.

11. The fuel tank system of claim 9, wherein the bypass means comprises one of a button, lever, arm and deformable housing, wherein movement of the bypass means urges the seal off of the seat to the open position.

12. A fuel tank system comprising:
a fuel tank;
a purge canister;
a housing;
a valve assembly configured in the housing and that is fluidly coupled between the fuel tank and the purge canister and that selectively controls fuel vapor flow between the fuel tank and the purge canister, the valve assembly having an over-pressure relief valve disposed therein, the over-pressure relief valve including a seal that translates between (i) an open position wherein the seal is offset from a corresponding seat and fuel vapor flows from the fuel tank to the purge canister and (ii) a closed position wherein the seal is engaged to the seat and fuel vapor is inhibited from flowing from the fuel tank to the purge canister; and
a device that manually and selectively urges the seal from the closed position to the open position.

13. The fuel tank system of claim 12 wherein the device comprises:
a pushpin enclosed by a flexible diaphragm in the housing, the pushpin selectively movable from an unactuated position to an actuated position, in the actuated position the pushpin manually urges the seal off of the corresponding seat thereby creating fuel vapor path from the fuel tank to the purge canister.

14. The fuel tank system of claim 13 wherein the pushpin is biased toward the unactuated position.

15. The fuel tank system of claim 12 wherein the seal includes magnetic material.

16. The fuel tank system of claim 15 wherein the device comprises a magnet, wherein placement of the magnet proximate to the seal urges the seal to translate away from the seat thereby creating a fuel vapor path from the fuel tank to the purge canister.

17. A fuel tank system comprising:
a fuel tank;
a purge canister;
a housing;
a valve assembly configured in the housing and that is fluidly coupled between the fuel tank and the purge canister and that selectively controls fuel vapor between the fuel tank and the purge canister;
a flow restrictor arranged in the housing and having a first seal that selectively translates between (i) an open position wherein the first seal is offset from a first seat and fuel vapor flows from the fuel tank to the purge canister and (ii) a closed position wherein the first seal is engaged to the first seat and fuel vapor is inhibited from flowing from the fuel tank to the purge canister; and
a device that manually and selectively urges the first seal from the closed position to the open position.

18. The fuel tank system of claim 17 wherein the device comprises a pull pin that extends from the housing, wherein manual actuation of the pull pin urges the first seal off of the first seat to the open position.

19. The fuel tank system of claim 17 wherein the device comprises one of a button, a lever, an arm and a deformable housing, wherein movement of the device urges the first seal off of the first seat to the open position.

20. The fuel tank system of claim 17 wherein the valve assembly further comprises an over-pressure relief valve disposed therein, the over-pressure relief valve including a second seal that translates between (i) an open position wherein the second seal is offset from a corresponding second seat and fuel vapor flows from the fuel tank to the purge canister and (ii) a closed position wherein the second seal is engaged to the second seat and fuel vapor is inhibited from flowing from the fuel tank to the purge canister.
